(19) United States
(12) Patent Application Publication
(10) Pub. No.: US 2022/0131387 A1
(43) Pub. Date: Apr. 28, 2022

(54) TOLERANCE-BAND FILTER FOR A FREQUENCY CONVERTER

(71) Applicant: Wobben Properties GmbH, Aurich (DE)

(72) Inventors: Christian HEYEN, Aurich (DE); Menko BAKKER, Aurich (DE)

(21) Appl. No.: 17/511,264

(22) Filed: Oct. 26, 2021

(30) Foreign Application Priority Data
Oct. 27, 2020 (EP) 20204138.0

(51) Int. Cl. H02J 3/48; H02J 3/38; H02M 7/5387

(52) U.S. Cl. CPC H02J 3/48; H02J 2300/28; H02M 7/53875; H02J 3/381

(57) ABSTRACT

Provided is a method for controlling a current converter, in particular an inverter, preferably a frequency converter comprising an inverter, in particular of a wind power installation. He method includes specifying a tolerance band that has at least one band limit for the current converter, in particular for one or more switching devices of the current converter, specifying a delay that includes a dead time, in particular for the switching devices, sensing an actual current of the current converter, in particular an actual current of the switching devices, comparing the sensed actual current with the band limit in order to determine a departure from the tolerance band, switching the current converter, in particular the switching devices, in order to come within the tolerance band, and suppressing further, in particular non-system-relevant, switching operations of the current converter, in particular of the switching devices, for the specified dead time

### BACKGROUND

### Technical Field

The present disclosure relates to a current converter, in particular a power converter of a wind power installation, and to a method for controlling such a current converter.

### Description of the Related Art

Current converters are static electrical devices for converting one type of electrical current (direct current, alternating current) into the respectively other type, or for changing characteristic parameters such as, for example, the amplitude or the frequency.

Current converters include rectifiers, inverters, frequency converters and DC-to-DC converters.

A rectifier converts alternating current into direct current.

An inverter converts direct current into alternating current.

A frequency converter converts a first alternating current into a second alternating current.

A DC-to-DC converter converts a first DC voltage into a second DC voltage.

In the case of frequency converters, the conversion of the type of current is generally effected with the aid of semiconductor-based electronic components such as, for example, insulated-gate bipolar transistors (IGBTs).

In the field of electrical power generation such as, for example, wind power installations, it is mostly current converters with a complex topology that are used, which include, for example, a large number of parallel, three-phase inverters, in order to feed the electrical current generated by the wind power installation into an electrical supply network.

The switching devices of such current converters in this case are usually actuated by use of switching signals generated by means of a control method such as, for example, a tolerance-band method.

Due to the topology of the current converter, for example because of the parallel operation of a plurality of inverters on a common DC link, and/or because of upstream or downstream filter elements, oscillation effects can occur within the current converter that result in unnecessary switching operations of the switching devices, which in turn can result in high losses within the current converter.

### BRIEF SUMMARY

One or more embodiments are directed to minimizing unnecessary switching operations within current converters, in particular while maintaining the high quality of the current generated by the current converter.

Proposed is a method for controlling a current converter, in particular an inverter, preferably a frequency converter comprising an inverter, in particular of a wind power installation, comprising the steps: specifying a tolerance band that has at least one band limit for the current converter, in particular for one or more switching devices of the current converter, specifying a delay that includes a dead time, in particular for the one or more switching devices of the current converter, sensing an actual current of the current converter, in particular an actual current of the one or more switching devices of the current converter, comparing the sensed actual current with the band limit in order to determine a departure from the tolerance band, switching the current converter, in particular the one or more switching devices of the current converter, in order to come within the tolerance band, suppressing further, in particular non-system-relevant, switching operations of the current converter, in particular of the one or more switching devices, for the specified dead time.

The method is thus preferably used to control a current converter, in particular a frequency converter, of a wind power installation. For this purpose, the current converter preferably has a control unit (e.g., controller) configured to execute a control method that generates switching signals by means of which the switching devices can be actuated, or controlled. The switching devices in this case are preferably based on semiconductor elements.

The current converter is also preferably realized as a power converter of a wind power installation, i.e., the current converter is a frequency converter or inverter that is configured to feed the electrical power generated by a generator of the wind power installation into an electrical supply network.

For this purpose, the current converter has, for example, a rectifier, which is electrically connected to a generator of the wind power installation and which in turn is electrically connected to an inverter. The inverter is also preferably connected via a transformer to an electrical supply network or an electrical wind farm network. Preferably, the current converter also has a DC link between the rectifier and the inverter.

The inverter also preferably has a plurality of switching devices such as, for example, IGBTs, which are preferably controlled by means of a control unit in such a way that a three-phase alternating current is generated by the inverter.

The switching devices in this case are preferably controlled by means of a tolerance-band method.

A tolerance-band method in this case is to be understood to mean, in particular, a hysteresis closed-loop control that has an upper limit, upper band limit, and a lower limit, lower band limit. The upper and the lower limit in this case define the range that can be occupied by the current of the inverter, in particular of the corresponding switching devices. If these limits are infringed by the exceeding of an actual current, the potentials are influenced by switching operations of the switching devices in such a manner that the current goes back to being within the limits.

In particular, it is proposed to control a power converter of a wind power installation by means of a tolerance-band method.

For this purpose, in a first step, a tolerance band that has an upper and a lower band limit is specified.

The tolerance band in this case is used, in particular, to control the switching devices of a phase of the current converter, in particular of the inverter.

In addition, a delay that includes a dead time is specified.

The delay in this case is intended, in particular, to suppress any switching operations of the switching devices.

Preferably, the delay, or dead time, is also used to ensure that a change in a current in another phase during a switching operation of the switching device(s) does not lead to a switching operation in the other phase. The delay, or dead time, therefore also suppresses switching operations in other switching devices of other phases if these would otherwise be triggered by the switching operation of the switching device(s).

In particular in this case, the dead time is used to set the duration of the suppression of the switching operations. The dead time is preferably freely settable for this purpose.

Furthermore, the actual current of the current converter, in particular the actual current of the switching device(s), is sensed.

The actual current sensed in this way is compared with the specified band limits, in particular in order to determine a departure from the tolerance band, the switching devices of the current converter being controlled by means of the control unit in such a way that the actual current remains within the tolerance band, or returns to it.

If the sensed actual current departs from the tolerance band, it is proposed in particular to suppress further switching operations, in particular non-system-relevant switching operations, of the current converter, in particular of the switching devices, for the specified dead time.

It is therefore proposed, in particular, to suppress switching operations for a specified dead time after the actual current has departed from the tolerance band. However, the switching operations are not suppressed for system-relevant switching operations such as, for example, switching operations for self-protection or switching operations against overcurrent.

The suppression of the switching operations in this case is preferably implemented by means of a software within the control unit of the current converter, also for example by means of a hardware-related programming, such as a field-programmable gate array (FPGA) design.

The proposed method, in particular the dead time, allows the closed-loop control to wait for a short time to see what the characteristic of the actual current will be after a switching operation. In this way, in particular unnecessary switching operations caused by possible resonant circuits such as, for example, closed-loop control resonant circuits or inductance-capacitance (LC) elements at the output of the current converter, can be avoided.

Preferably, a suppression signal, sent by the control unit to the switching devices with the switching signal, is used to suppress further switching signals. The control unit therefore always sends signals comprising a control signal and a suppression signal, the suppression signal including the dead time. This may be realized, for example, by means of a tolerance-band closed-loop controller and a setpoint switching-signal closed-loop control, which is implemented on one, in particular the same, FPGA.

In a further embodiment, the delay may be implemented, for example, by means of a flip-flop or set-reset element (SR element for short).

The dead time in this case is preferably adapted to the topology of the current converter in such a manner that unnecessary switching operations are avoided particularly effectively. The dead time is therefore in particular a deliberately selected and implemented delay, which is to be distinguished from any signal propagation times.

Preferably, the dead time is selected to be greater than a time constant of a resonant circuit of the current converter on the generator side or network side.

Since further electronic components such as, for example, filters, chokes, generators and/or electrical networks, are connected to both an input and an output of the current converter, resonant circuits are formed both at the input and at the output of the current converter.

In particular, it is therefore also proposed to set the dead time taking into account these resonant circuits, in particular in such a way that the dead time is greater than the time constant of these resonant circuits, e.g., the dead time is a few periods (less than 10), preferably one period, more preferably half a period.

Preferably, the dead time is selected to be less than a time constant that results in a virtual enlargement of the tolerance band by more than 10 percent, in particular 15 percent, 25 percent.

Using a dead time results in a virtual enlargement of the tolerance band, in particular since suppressed switching operations may be effected later if, for example, the actual current is still outside the tolerance band after the delay. This delayed switching results, in particular figuratively speaking, in a virtual enlargement of the tolerance band.

It is precisely for such cases that it is proposed to select the dead time in such a way that the tolerance band is not virtually enlarged by more than 25 percent.

In particular, this also means that, if this limit is exceeded, the corresponding switching operation is effected.

To this extent, it is therefore also proposed that the dead time is selected so as not to be too long and preferably only waits for a very short time, in particular in order to determine whether the actual current falls within the tolerance band by itself. If the actual current does not fall within the tolerance band by itself, the corresponding switching operation is delayed by the dead time, or effected with that delay.

Preferably, the dead time is implemented by closed-loop control.

It is therefore proposed, in particular, to implement the dead time in a closed-loop control system, e.g., in a corresponding control software.

This may be effected, for example, in that the control unit transmits to the switching devices signals that include both switching signals and the dead time.

Alternatively, however, the dead time may also be implemented by hardware, e.g., by means of RC elements.

Preferably, the dead time is between 10 and 100 microseconds (μs).

Additionally proposed according to the disclosure is a current converter, in particular a frequency converter of a wind power installation, at least comprising: an inverter having a plurality of switching devices and a control unit for the inverter, wherein the control unit is configured to execute a method described above or below.

The current converter is thus realized, in particular, as a frequency converter of a wind power installation.

For this purpose, the current converter comprises, for example, a plurality of switching devices, e.g., IGBTs, and a control unit that is configured to control the switching devices, e.g., by means of a tolerance-band method and/or hysteresis method.

For this purpose, the control unit is connected to the switching devices, for example via signal lines, and is configured to transmit to the switching devices signals that include, in particular, a switching signal and a dead time.

In a particularly preferred embodiment, the dead time is set during operation of the current converter by means of an observer, preferably a state observer, e.g., according to Kalman, or by means of the Kalman criterion.

In addition, the control unit is configured to execute a computer program product, in particular a software, that determines both the switching signal and the dead time.

Furthermore, the control unit is configured to control the switching devices by means of a tolerance-band method and/or hysteresis method.

Preferably, the current converter is realized as a power converter of a wind power installation.

In particular, the current converter is therefore configured and used to feed the electrical power generated by a generator of the wind power installation into an electrical supply network.

Preferably, the switching devices comprise at least one IGBT and/or are realized as an IGBT.

The switching devices are thus based in particular on semiconductor elements that are configured to carry high currents.

Additionally proposed is a wind power installation, comprising at least one current converter described above or below, wherein the current converter is realized as a power converter, and in particular is configured to feed an electrical power generated by the wind power installation into an electrical supply network.

### BRIEF DESCRIPTION OF THE SEVERAL VIEWS OF THE DRAWINGS

The present invention is now explained in more detail below on the basis of exemplary embodiments with reference to the accompanying figures, with the same references being used for assemblies that are the same or similar.

FIG. 1 shows a schematic view of a wind power installation according to an embodiment.

FIG. 2 shows a schematic structure of an electrical train of a wind power installation for feeding-in an electrical alternating current according to an embodiment.

FIG. 3 shows, in schematic form, the structure of a current converter for generating an electrical three-phase alternating current by means of a tolerance-band method according to an embodiment.

FIG. 4 shows the sequence of a common method for controlling a current converter by means of a tolerance-band method (prior art).

FIG. 5 shows the sequence of a method for controlling a current converter by means of a tolerance-band method.

### DETAILED DESCRIPTION

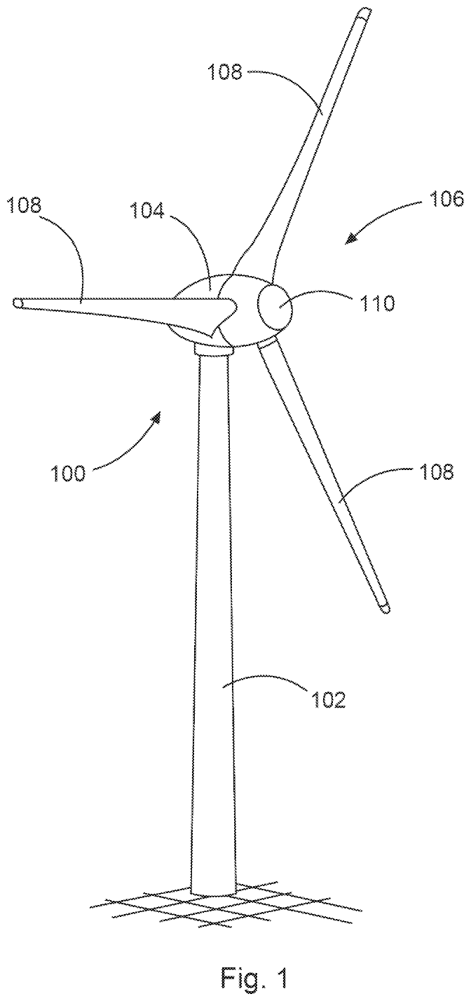

FIG. 1 shows a schematic view of a wind power installation 100 according to an embodiment.

For this purpose, the wind power installation 100 has a tower 102 and a nacelle 104. Arranged on the nacelle 104 there is an aerodynamic rotor 106 that has three rotor blades 108 and a spinner 110. During operation, the wind causes the rotor 106 to rotate, thereby driving a generator in the nacelle 104.

In addition, the generator is connected to a current converter, described above or below, which feeds the electrical power generated by the generator into an electrical supply network, in particular an electrical wind farm network.

For the purpose of operating the wind power installation, and in particular the current converter, a control unit, described above or below, is also provided.

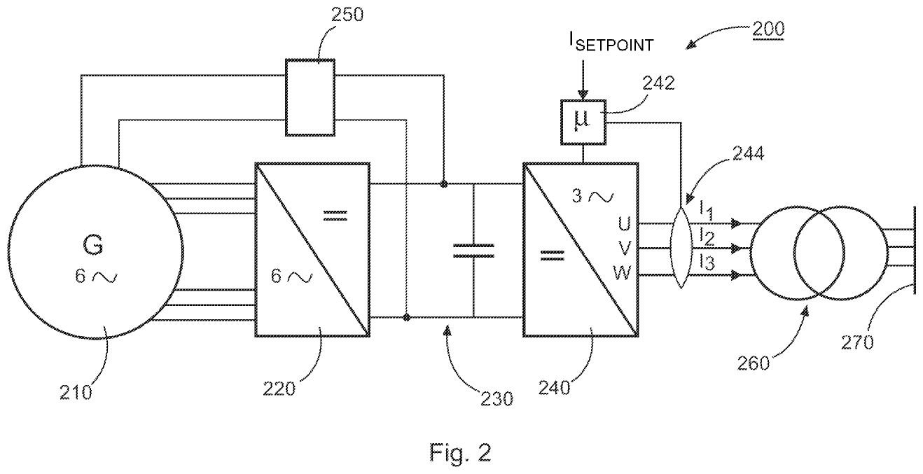

Shown in simplified form in FIG. 2 is an electrical train 200 of a wind power installation shown in FIG. 1.

The electrical train 200 has a 6-phase ring generator 210 which is rotated by the wind, via a mechanical drive train of the wind power installation, in order to generate a 6-phase alternating electrical current.

The 6-phase electrical alternating current is transmitted by the generator 210 to the rectifier 220, which is connected to the 3-phase inverter 240 via a DC link 230. The 6-phase ring generator 210, which is realized as a synchronous generator, is in this case electrically excited via the excitation 250 from the DC link 230.

The electrical train 200 thus has a full frequency converter concept, in which feed-in to the network 270 is effected by means of the 3-phase inverter 240, via the wind power installation transformer 260.

Such frequency converters, which feed the electrical power generated by the generator of the wind power installation into an electrical supply network, are usually also referred to as power converters.

The network 270 is usually an electrical wind farm network that feeds into an electrical supply network via a wind farm transformer. However, a direct in-feed, directly into the electrical supply network, may also be a possibility.

For the purpose of generating the three-phase current I1, I2, I3 for each of the phases U, V, W, the inverter 240 is controlled by means of a tolerance-band method.

The control in this case is effected via the control unit (e.g., controller) 242, which, by means of a current sensing device (e.g., ammeter or multimeter) 244, senses each of the three currents I1, I2, I3 generated by the inverter 240.

The control unit 242 is thus configured, in particular, to control each phase of the inverter individually by means of the current sensing device 244. For this purpose, the control unit 242 may receive, for example, a current setpoint Iₛₑₜₚₒᵢₙₜ from the wind power installation control, in dependence on which the respective currents I1, I2, I3 are set.

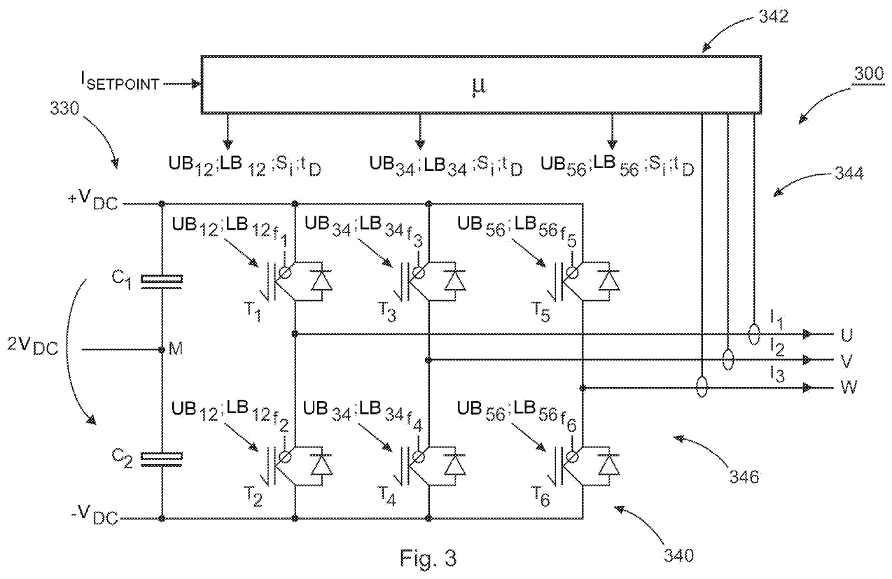

Shown schematically in FIG. 3 is the structure of a current converter 300, in particular the inverter 240 shown in FIG. 2, for generating an electrical three-phase alternating current by means of a tolerance-band method.

The current converter 300 is realized as an inverter, and is connected to a DC link 330 that is connected to the generator of a wind power installation via a rectifier.

The DC link 330 has a first potential +V_{dc} and a second potential −V_{dc} with a center tap M that is configured to be connected to a filter, for example in order to feed back a filter, connected to the output 346 of the inverter, to the DC link 330.

In addition, arranged between the center tap M and the two potentials +V_{dc}, −V_{dc} there is a respective capacitor comprising the capacitor device C1, C2, in order to store energy in the DC link 330 and to smooth the DC voltage 2V_{dc} accordingly.

The current converter 300, which is connected to the DC link 330, generates a separate current I1, I2, I3 for each of the three phases U, V, W at the output 346 of the current converter 340. For this purpose, the current converter 340 has two switching devices for each of the three phases U, V, W, namely an upper switch T1, T3, T5 and a lower switch T2, T4, T6, the upper and lower switches T1, T2, T3, T4, T5, T6 being controlled, in particular, via the control unit by means of a tolerance-band method.

The control unit 342 itself operates with a current-guided tolerance-band method. For this purpose, the control unit 342 senses the currents I1, I2, I3 generated by the inverter 340 at the output 346 of the current converter 340 by means of a current sensing device 344. The currents I1, I2, I3 sensed thus are compared with a setpoint value Iₛₑₜₚₒᵢₙₜ in order to determine the band limits UB12, LB12, UB34, LB34, UB56, LB56 for upper and lower switches T1, T2, T3, T4, T5, T6.

The switching devices T1, T2, T3, T4, T5, T6 are thus controlled by the control unit 342 by means of band limits UBᵢ, LBᵢ, switching signals Sᵢ and dead times t_{D}, in particular in order to generate a three-phase current I1, I2, I3.

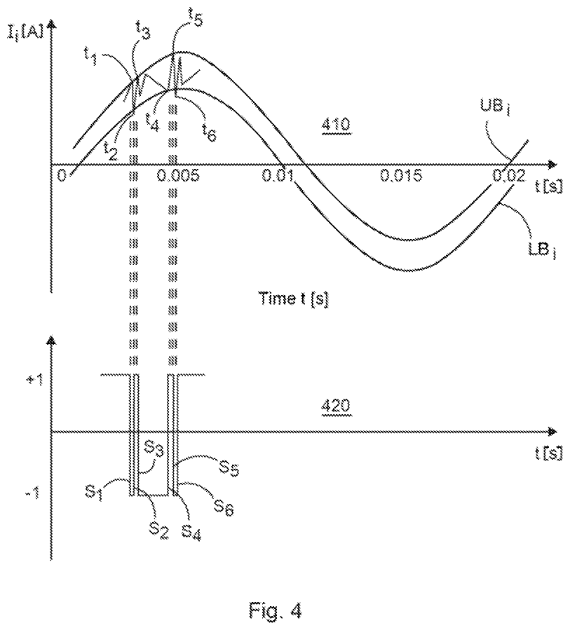

FIG. 4 shows the sequence 400 of a common method for controlling a current converter by means of a tolerance-band method (prior art).

In the upper part 410 of FIG. 4, the current Iᵢ of a switching device is plotted over time t, and in the lower part 420 the corresponding switching operations Sᵢ.

At instant t1, the current Iᵢ exceeds the upper band limit UBᵢ, whereupon the switching device switches from +1 to −1 by means of switching operation S1.

This causes a spike, which at instant t2 results in the lower band limit LBᵢ being undershot.

This causes the switching operation S2 to be effected, which in turn results in a spike, which in turn results in the upper band limit UBᵢ being exceeded at the instant t3.

The switching operation S1 therefore triggers two further switching operations S2 and S3.

At a later instant t4, the current Iᵢ falls below the lower band limit LBᵢ, whereupon the switching device switches from −1 to +1 by means of the switching operation S4.

This in turn results in a spike, which results in the switching operations S5 and S6 to the instants t5 and t6.

Two further switching operations S5 and S6 are therefore also triggered by the switching operation S4.

In the case of common tolerance-band methods, therefore, resonant circuits upstream or downstream of the current converter can cause dissipative, and thus unnecessary, switching operations.

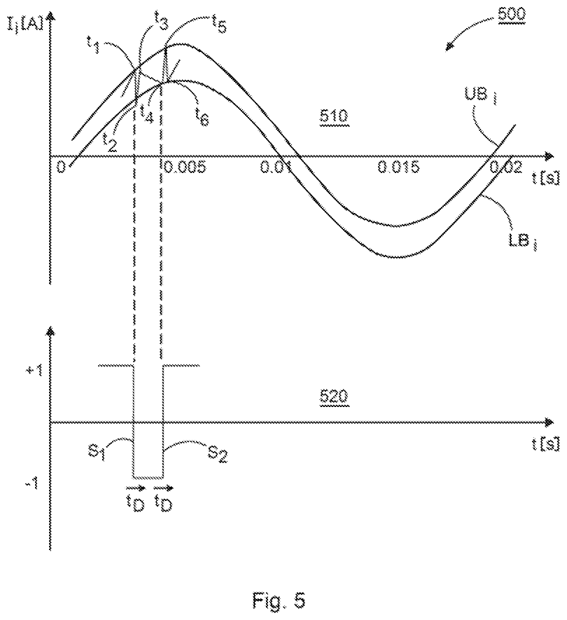

FIG. 5 shows the sequence of a method for controlling a current converter by means of a tolerance-band method, in particular for avoiding unnecessary switching operations.

In the upper part 510 of FIG. 5, the current Iᵢ of a switching device is plotted over time t, and in the lower part 520 the corresponding switching operations Si.

At instant t1, the current Iᵢ exceeds the upper band limit UBᵢ, whereupon the switching device switches from +1 to ˜1 by means of switching operation S1.

This causes a spike, which at instant t2 results in the lower band limit LBᵢ being undershot.

The under-shooting of the lower band limit LBᵢ would normally result in a further switching operation, as shown for example in FIG. 4.

However, this switching operation is suppressed by the dead time t_{D}.

The spike disappears again at instant t3, such that the current continues to move within the tolerance band UBᵢ, LBᵢ.

At a later instant t4, the current Iᵢ falls below the lower band limit LBᵢ, whereupon the switching device switches from −1 to +1 by means of the switching operation S4.

This in turn results in a spike, which would normally result in further switching operations at the instants t5 and t6, as shown for example in FIG. 4.

However, these further switching operations are likewise suppressed by the dead time t_{D}.

Unnecessary further switching operations are avoided by means of an additional dead time t_{D}, as a comparison with FIG. 4 shows.

It is therefore proposed, in particular, that the closed-loop control waits for a short time to see what the characteristic of the current will be. Only after the dead time has elapsed are further switching operations effected, if necessary.

In this respect it is also proposed, in particular, that, if the current is outside of the tolerance band UBᵢ, LBᵢ after the dead time t_{D} has elapsed, further switching operations are effected, which bring the current back into the tolerance band UBᵢ, LBᵢ.

### LIST OF REFERENCES

100 wind power installation
102 tower, in particular of the wind power installation
104 nacelle, in particular of the wind power installation
106 aerodynamic rotor, in particular of the wind power installation
108 rotor blade, in particular of the wind power installation
110 spinner, in particular of the wind power installation
200 electrical train, in particular of the wind power installation
210 generator, in particular of the wind power installation
220 rectifier, in particular of the wind power installation
230 DC link, in particular of the wind power installation
240 inverter, in particular of the wind power installation
242 control unit, in particular of the inverter
244 current sensing, in particular of the inverter
250 excitation, in particular of the generator
260 transformer, in particular of the wind power installation
270 electrical network
300 current converter, in particular inverter
330 DC link, in particular for the current converter
342 control unit, in particular of the current converter
344 current sensing, in particular of the current converter
346 output, in particular of the current converter
400 sequence of a common method (prior art)
500 sequence of a method
Iᵢ current
t time
t_{D} dead time
Sᵢ switching operations
I1, I2, I3 three-phase alternating current, in particular of the wind power installation
T1, . . . , T6 switching devices, in particular of the current converter
T1, T3, T5 upper switches, in particular of the current converter
T2, T4, T6 lower switches, in particular of the current converter
UBᵢ upper band limit
UB12 upper band limit, in particular for the first and second switching devices
UB34 upper band limit, in particular for the third and fourth switching devices
UB56 upper band limit, in particular for the fifth and sixth switching devices
LBᵢ lower band limit
LB12 lower band limit, in particular for the first and second switching devices
LB34 lower band limit, in particular for the third and fourth switching devices
LB56 lower band limit, in particular for the fifth and sixth switching devices
U, V, W phases of the electrical network
V_{dc} intermediate-circuit voltage, in particular of the DC link
+V_{ac} first potential, in particular of the DC link
−V_{dc} second potential, in particular of the DC link

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for controlling a current converter of a wind power installation, comprising:
specifying a tolerance band that has at least one band limit for one or more switching devices of the current converter;
specifying a delay that includes a dead time for the one or more switching devices of the current converter;
sensing a current of the one or more switching devices of the current converter,
comparing the sensed current with the band limit to determine a departure from the tolerance band;
switching the one or more switching devices of the current converter to bring the current within the tolerance band; and
suppressing further switching operations of the one or more switching devices for the dead time.

2. The method as claimed in claim 1, wherein the current converter is an inverter.

3. The method as claimed in claim 1, wherein the current converter is a frequency converter including an inverter.

4. The method as claimed in claim 1, wherein suppressing the further switching operations includes suppressing non-system-relevant switching operations.

5. The method as claimed in claim 1, comprising:
selecting the dead time to be greater than a time constant of a resonant circuit of the current converter on a generator side of the current converter or a network side of the current converter.

6. The method as claimed in claim 1, comprising:
selecting the dead time to be less than a time constant that results in a virtual increase of the tolerance band by more than 10 percent.

7. The method as claimed in claim 6, comprising:
selecting the dead time to be less than a time constant that results in a virtual increase of the tolerance band by more than 25 percent.

8. The method as claimed in claim 1, wherein the dead time is implemented by closed-loop control.

9. A current converter of a wind power installation, comprising:
a plurality of switching devices; and
a controller configured to:
specify a tolerance band that has at least one band limit for the plurality of switching devices;
specify a delay that includes a dead time for the plurality of switching devices;
receive a sensed current of the plurality of switching devices of the current converter;
compare the sensed current with the at least one band limit to determine a departure from the tolerance band;
switch the plurality of switching devices to bring the sensed current within the tolerance band; and
suppress further switching operations of the plurality of switching devices.

10. The current converter as claimed in claim 9, wherein the current converter is a frequency converter.

11. The current converter as claimed in claim 9, wherein the current converter is a power converter of a wind power installation.

12. The current converter as claimed in claim 9, wherein the plurality of switching devices include at least one insulated-gate bipolar transistor (IGBT).

13. A wind power installation, comprising:
at least one current converter as claimed in claim 9, wherein the current converter is a power converter and is configured to feed an electrical power generated by the wind power installation into an electrical supply network.
